(19) United States
(12) Patent Application Publication
(10) Pub. No.: US 2006/0061537 A1
(43) Pub. Date: Mar. 23, 2006

(54) DISPLAY

(76) Inventors: Chuan-Pei Yu, I-Lan Hsien (TW); Chang-Yu Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,867

(22) Filed: Mar. 10, 2005

(30) Foreign Application Priority Data
Sep. 23, 2004 (TW) 093128881

(51) Int. Cl. G09G 3/36

(52) U.S. Cl. 345/102

(57) ABSTRACT

A flat display module has a light guide plate, at least an optical film, and a flat display panel. The light guide plate has at least a fastener, and the optical film has at least a breach corresponding to the fastener so that the fastener can fasten the optical film to the light guide plate.

### BACKGROUND OF INVENTION

1. Field of the Invention

The present invention provides a flat display module, and more particularly, a flat display module not requiring a housing.

2. Description of the Prior Art

With the rapid development of technology, light, power-saving, and portable intelligent information products are filling up our lives, wherein the flat display module plays a key role. Due to the characteristics of light weight, low power consumption, thin and little radiation pollution, liquid crystal display modules are widely applied to information products, such as notebooks, personal digital assistants (PDAs), mobile phones, etc. Liquid crystal display modules are also replacing the CRT monitor and the conventional TV.

Generally, a liquid crystal display module includes a liquid crystal display panel, a light source, a light guide plate, and several kinds of optical films. Please refer to FIG. 1. FIG. 1 is a cross-sectional view of a conventional liquid crystal display module 10. As shown in FIG. 1, the liquid crystal display module 10 includes a liquid crystal display panel 12, a light guide plate 14 disposed beneath the liquid crystal display panel 12, a diffusion sheet 18 and a prism sheet 16 positioned between the light guide plate 14 and the liquid crystal display panel 12, a reflecting sheet 20 disposed beneath the light guide plate 14, and a housing 22. In addition, the liquid crystal display module 10 further includes a light source (not shown), positioned to the side of the light guide plate 14, for providing light required for displaying images on the liquid crystal display panel 12. The light guide plate 14 is used for uniformly conducting the light produced from the light source 14 to the diffusion sheet 18, and the diffusion sheet 18 further scatters the light passed through so as to provide the display panel 12 with more homogeneously scattered light. The main function of the prism sheet 16 is to enhance the brightness of the liquid crystal display module 10, which principle is similar to the light gathering effect of the light guide plate 14. In addition, the prism sheet 16 may further correct the diversity of the illumination intensity, and enable the light received by the display panel 12 to possess a more uniform distribution of illumination intensity. The function of the reflecting sheet 20 is to reflect the light emitted from the bottom of the light guide plate 14 back to the light guide plate 14 to improve the light utilization rate. Moreover, the housing 22 is utilized to fasten the liquid crystal display panel 12, the prism sheet 16, the diffusion sheet 18, the light guide plate 14, and the reflecting sheet 20.

Conventionally, the housing 22 of the liquid crystal display module 10 is made of metallic materials, while the present industry utilizes plastic materials instead of the metallic materials. No matter if metallic or plastic materials are used, the housing 22 possesses certain thickness and weight that limit development of a miniaturized liquid crystal display module 10. Thus, the size and design of the end products, such as mobile phones, PDAs, and so on may thus be constrained.

Therefore, there is a need to improve the design of the conventional flat display module to meet the light-weight and small-size requirements of consumer products.

### SUMMARY OF INVENTION

It is therefore a primary objective of the present invention to provide a flat display module having a particularly designed light guide plate for solving the aforementioned problems.

According to the claimed invention, a flat display module including a light guide plate, at least an optical film, and a flat display panel is provided. The light guide plate includes a transmission plate, and at least a fastener protruding from the surface of the transmission plate. The optical film is positioned at the top of the light guide plate, and has at least a breach corresponding to the fastener. In addition, the flat display panel is disposed on the optical film and the light guide plate.

The flat display module of the present invention utilizes fasteners located on the surface of the light guide plate and the breaches of the optical film disposed thereon to fasten the optical film on the light guide plate, or in coordination with an adhesive to fasten the flat display panel on the optical film or the fasteners. Thus, there is no housing required in the present invention to which to fasten each element so that the production cost and complexity can be substantially reduced, and the size and weight can be reduced to miniaturize the flat display module.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a cross-sectional view of a conventional liquid crystal display module.

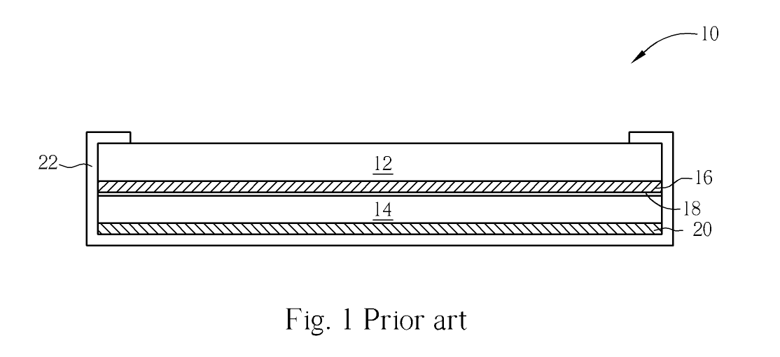

FIG. 2 is a cross-sectional view of a flat display module according to a first preferred embodiment of the present invention.

FIG. 3 is a perspective diagram of a light guide plate and a diffusion sheet shown in FIG. 2.

FIG. 4 is a cross-sectional view of a flat display module according to a second preferred embodiment of the present invention.

FIG. 5 is a side view of a flat display module according to a third preferred embodiment of the present invention.

FIG. 6 is a perspective diagram of a light guide plate and a diffusion sheet shown in FIG. 5.

FIG. 7 is a side view of a flat display module according to a fourth preferred embodiment of the present invention.

FIG. 8 is a top view of a flat display module shown in FIG. 7.

FIG. 9 is a cross-sectional view of a flat display module according to a fifth preferred embodiment of the present invention.

FIG. 10 is a perspective diagram of a light guide plate and a diffusion sheet shown in FIG. 9.

### DETAILED DESCRIPTION

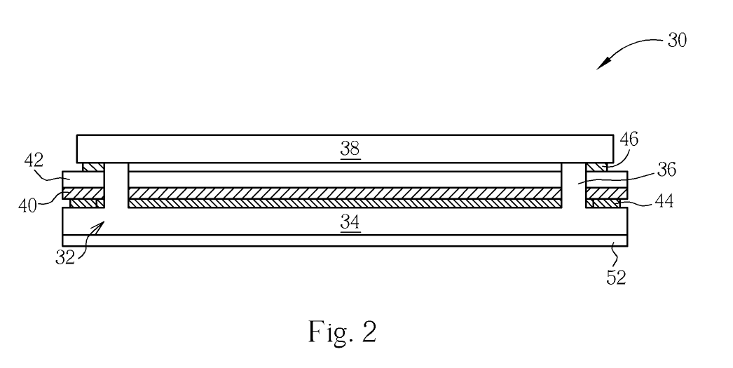

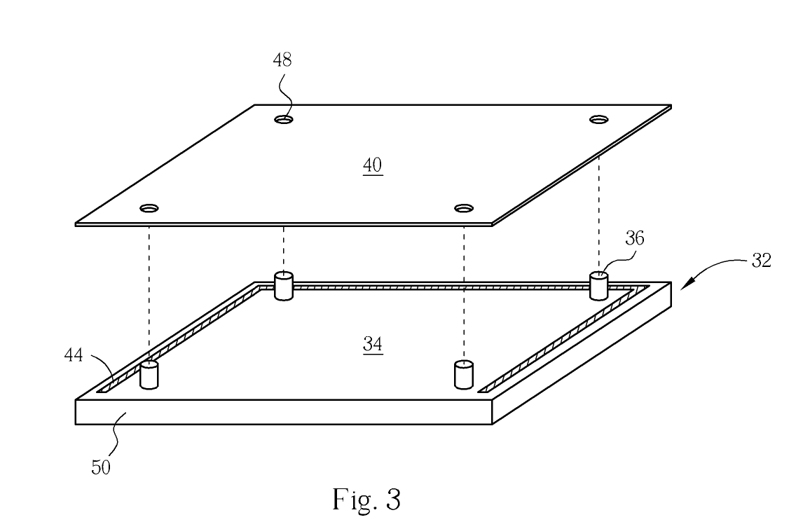

Please refer to FIG. 2 and FIG. 3. FIG. 2 is a cross-sectional view of a flat display module 30 according to a first preferred embodiment of the present invention. FIG. 3 is a perspective diagram of a light guide plate 32 and a diffusion sheet 40 shown in FIG. 2. The flat display module 30 includes a light guide plate 32, a flat display panel 38, a refection sheet 52 disposed to the bottom of the light guide plate 32, and a plurality of optical films, such as a flexible reflective polarizing film, or the diffusion sheet 40 and the prism sheet 42 as shown in FIG. 2. In the present embodiment, the flat display module 30 is a liquid crystal display module so that the flat display panel 38 is a liquid crystal display panel. The flat display module 30 of the present invention further includes a light source (not shown in the figure), disposed to the side of the light guide plate 32 so that the light can penetrate from an incident plane 50 into the light guide plate 32. The light guide plate 32 includes a transmission plate 34 and a plurality of fasteners 36 protruding from a light-exit plane of the transmission plate 34. In the present embodiment, each fastener 36 is cylindrical, and is disposed at one of the four corners of the rectangular light guide plate 32. The diffusion sheet 40 and the prism sheet 42 are sequentially positioned on the top of the light guide plate 32, and each of these has a plurality of breaches corresponding to the fastener 36, wherein the amounts and order of the diffusion sheet 40 and the prism sheet 42 can be varied according to a specific design of the end products. FIG. 2 simply shows a layer of the prism sheet 42. Taking the diffusion sheet 40 shown in FIG. 3 for example, there are four breaches 48, such as holes, each disposed at one of the four corners of the rectangular diffusion sheet 34. Therefore, when the diffusion sheet 40 is placed above the light guide plate 32, the fastener 36 can pass through the breach 48 so that the diffusion sheet 40 can be fastened to the light guide plate 32 to secure it. Thermal welding can also be applied to combine the diffusion sheet 40 as well as the prism sheet 42 with the fastener 36.

Furthermore, a layer of adhesive 44 can be optionally disposed around the fasteners 36 of the light guide plate 32 to assist in fastening the diffusion sheet 40 to the top of the light guide plate 32. As shown in FIG. 3, the adhesive 44 is disposed around the fasteners 36 for enhancing the fixation of the optical film above the light guide plate 32. The adhesive 44 can be twin adhesive, UV glue, or hot glue. An adhesive can also be placed between the optical films, for instance, between the diffusion sheet 40 and the prism sheet 42 (not shown) to enhance the fixation of the optical films.

On the other hand, to fasten the flat display panel 38 to the optical film and the light guide plate 32, a layer of adhesive 46 can be placed on the top optical film or the fasteners 36. In the present embodiment, the adhesive 46 is placed to the surface of the prism sheet 42, and the adhesive can be UV glue, hot glue, or twin adhesive.

Since the light guide plate 32 of the flat display module 30 of the present invention has the fasteners 36 that pass through the corresponding breaches 18 of the optical films, for example, the diffusion sheet 40 and the prism sheet 42, the present invention can fasten a plurality of optical films to the light guide plate 32 without utilizing a housing of the conventional flat display module so that the cost and the size of the flat display module 30 can be reduced. In addition, it should be noted that the size of the light guide plate 32 must be slightly larger than that of the flat display panel 38 for preventing the elements of an end product from colliding or scratching the flat display panel 38 as the flat display module 30 is fit into the end product. Moreover, the amounts and positioning sites of the fasteners 36 are not limited to what FIG. 3 shows, and can be designed according to any practical requirement.

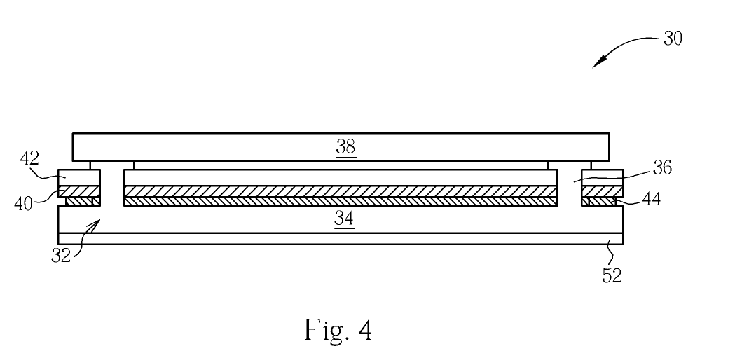

Please refer to FIG. 4. FIG. 4 is a cross-sectional view of a flat display module 30 according to a second preferred embodiment of the present invention. For convenience, for the same parts the reference numerals shown in FIG. 4 are the same as those shown in FIG. 2. In FIG. 4, the top of each fastener 36 is monolithically formed with the light guide plate 32 or is formed with an enlarged head by means of subsequent processing. That is, the top of each fastener 36 is slightly larger than the corresponding breach 48 of the diffusion sheet 40 and the prism sheet 42 so that they will not slide toward the flat display panel 38 after assembly.

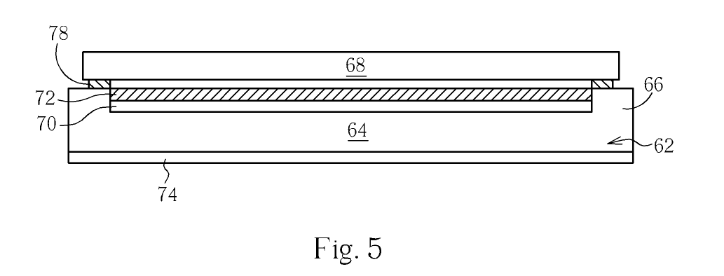

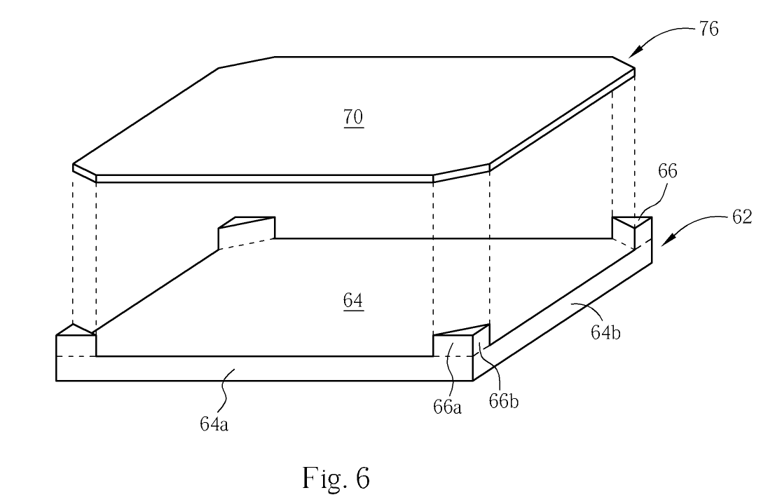

Please refer to FIG. 5 and FIG. 6. FIG. 5 is a side view of a flat display module 60 according to a third preferred embodiment of the present invention. FIG. 6 is a perspective diagram of a light guide plate 62 and a diffusion sheet 70 shown in FIG. 5. The flat display module 60 shown in FIG. 5 includes a light guide plate 62, a diffusion sheet 70, a prism sheet 72, a reflection sheet 74, and a flat display panel 68. The light guide plate 62 includes a transmission plate 64 and a plurality of fasteners 66 protruding from the surface of the transmission plate 64. It is noted that each fastener 66 is a triangular prism including at least two sides 66a and 66b, which are coplanar respectively with the two sides 64a and 64b of the transmission plate 64. That is, one of the vertex corners of each triangular prism 66 is extended to one of the vertex corners of the rectangular transmission plate 64, and the cross-section of each fastener 66 is in the shape of a right triangle.

A plurality of optical films including the diffusion sheet 70 and the prism sheet 72 are placed on the light guide plate 62. Taking the diffusion sheet 70 as an example, it includes four breaches 76 corresponding respectively to the fasteners 66 of the light guide plate 62. When placing the diffusion sheet 70 on the topside of the light guide plate 62, each fastener 66 is just located at the corresponding breach 76 such that the diffusion sheet 70 will be clipped to the topside of the transmission plate 64 firmly without moving. Similarly, the prism sheet 72 has four breaches corresponding to the fasteners 66, and the fasteners 66 fasten the prism sheet 72 on the diffusion sheet 70 as the prism sheet 72 is placed above the diffusion sheet 70.

In the present embodiment, the top surface of each fastener 66 is further coated with a layer of adhesive 78 for fastening the flat display panel 68 to the light guide plate 62 and the prism sheet 72. In addition, a layer of adhesive, such as UV glue, hot glue, or twin adhesive can be disposed between the edge of each optical film and that of the flat display panel 68 (not shown) to enhance the fastening effect.

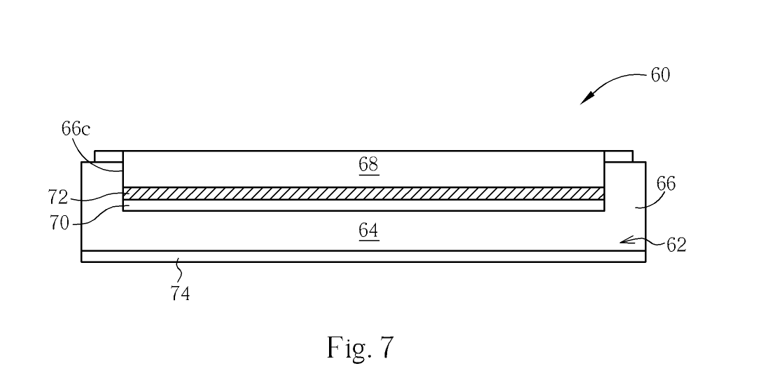

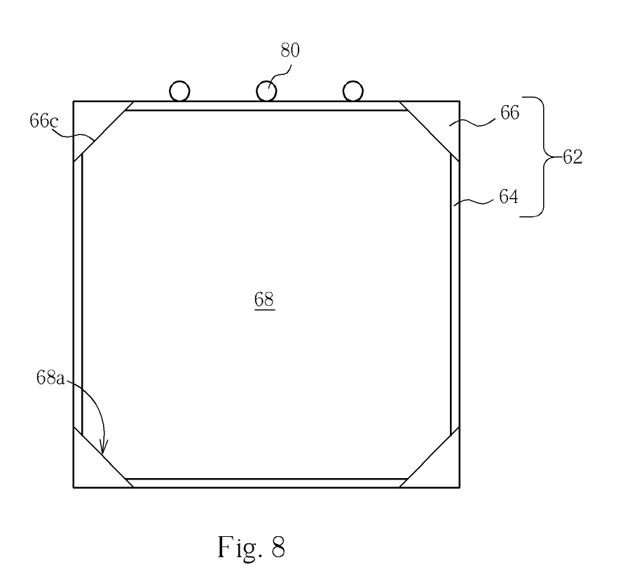

Please refer to FIG. 7 and FIG. 8. FIG. 7 is a side view of a flat display module 60 according to a fourth preferred embodiment of the present invention, while FIG. 8 is a top view of a flat display module 60 shown in FIG. 7. Elements in FIG. 7 and FIG. 8 like those in FIG. 5 and FIG. 6 have the same reference numerals. The light guide plate 62 shown in FIG. 7 includes four fasteners 66 in the shape of a triangular prism located at the four corners of the transmission plate 64. The two sides of each fastener 66 are coplanar with the two sides of the transmission plate 64. In addition, the flat display panel 68 has for breaches 68a. Therefore, when the flat display panel 68 is placed on the prism sheet 72, the fasteners 66 will be located at the four breaches 68a of the flat display panel 68, so that the flat display panel 68 can be fastened to the four fasteners 66 and held without moving. On the other hand, a glue or adhesive can be optionally disposed either to one surface of the side 66c of each fastener 66 or between each optical film and the flat display panel 68 for assisting in fastening each optical film and the flat display panel 68 (not shown). Furthermore, as shown in FIG. 8, the flat display module 60 includes at least a light source generator 80 disposed to the side of the light guide plate 62, and the light source generator 80 can be selectively chosen as light emitting diodes (LEDs) or another conventional light source.

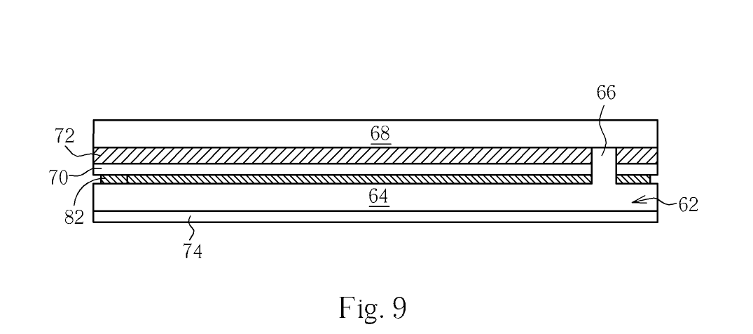

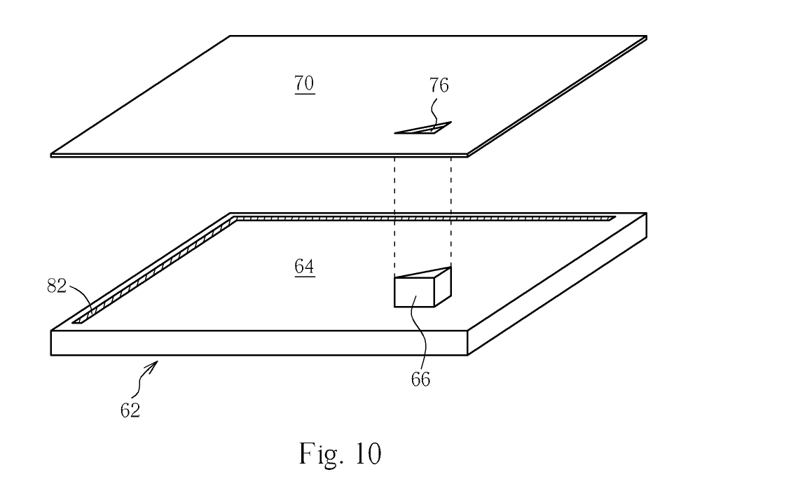

Please refer to FIG. 9 and FIG. 10. FIG. 9 is a cross-sectional view of a flat display module 60 according to a fifth preferred embodiment of the present invention, and FIG. 10 is a perspective diagram of a light guide plate 62 and a diffusion sheet 70 shown in FIG. 9. For convenience, for the same elements, reference numerals in FIG. 9 and FIG. 10 are the same as those in FIG. 5 and FIG. 6. As shown in FIG. 9 and FIG. 10, the surface of the light guide plate 62 simply has a fastener 66 which is in the shape of a triangular pillar, while the diffusion sheet 70 includes a breach 76 corresponding to the fastener 66, that is, a triangular opening. Therefore, as the diffusion sheet 76 is placed on the light guide plate 62, the triangular fastener 66 will penetrate the breach 76 of the diffusion sheet 76, and fasten the diffusion sheet 76 to the surface of the light guide plate 62 to prevent it from moving. Similarly, the prism sheet 72 also includes a triangular breach corresponding to the fastener 66 for the penetration of the fastener 66 and fastening thereto. On the other hand, an adhesive 82 can be selectively disposed to the surface of the transmission plate 64 and between each optical film and the flat display panel 68 for assisting in fastening the optical films which are disposed to the surface of the transmission plate 64.

Furthermore, in the present embodiment, the cross-section of the fastener 66 is not limited to be triangular, any polygonal other than circular shape can be used. For example, the fastener could be tetragonal, pentagonal, etc. or any other shape that can confine movement and rotation in the horizontal direction. The breach of the optical film has to be designed corresponding to the fastener therein so that the optical film can be fastened to the surface of the light guide plate 62 by simply one fastener 66.

In a sixth embodiment of the present invention, the fasteners located on the surface of the light guide plate are designed by a combination of the first and the third embodiments of the present invention. Each fastener can thus be a triangular prism which is disposed respectively to the vertex corners of the rectangular transmission plate and of which two sides are coplanar with the sides of the transmission plate, or a circular prism penetrating the optical film for optimizing the fastening effect of the optical film.

Since the light guide plate of the flat display module of the present invention has a specially designed fastener, and in coordination with optical films having corresponding breaches, the optical films can be fastened to the surface of the light guide plate without using the housing of the conventional flat display module. Thus, the cost and complexity of manufacture can be reduced, and the size of the flat display module of the present invention can be reduced by at least the thickness of one housing. By virtue of no housing, when the flat display module of the present invention is assembled into an end product, the outer casing of the end product can be used for further protection, if required. For example, the present invention flat display module can be installed inside an end-product cellular phone by utilizing the outer casing of the cellular phone as its housing, and thus, the size of the liquid crystal display module as well as that of the end product can be effectively reduced. As described above, the flat display module of the present invention can effectively improve the size limitation of the conventional flat display module having a housing, and further meet the demand of further miniaturization of flat display modules.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A flat display module comprising:
a light guide plate, the light guide plate comprising:
a transmission plate; and
at least a fastener protruding from a surface of the transmission plate;
at least an optical film disposed to a top surface of the light guide plate, the optical film having at least a breach corresponding to the fastener; and
a flat display panel disposed on the optical film.

2. The flat display module of claim 1, wherein the breach is a hole and the fastener passes through the hole.

3. The flat display module of claim 2, wherein the fastener has an enlarged head.

4. The flat display module of claim 1, wherein the light guide plate comprises a plurality of fasteners, and the optical film has a plurality of breaches corresponding to the fasteners.

5. The flat display module of claim 4, wherein the fasteners are disposed on four corners of the transmission plate.

6. The flat display module of claim 4, wherein each of the fasteners comprises at least two sides that are respectively coplanar with two sides of the transmission plate.

7. The flat display module of claim 6, wherein the fasteners are located respectively at the breaches of the optical film for fastening the optical film on the transmission plate.

8. The flat display module of claim 6, wherein the flat display panel comprises a plurality of breaches corresponding to the fasteners, and the fasteners are located respectively at the breaches of the display panel so as to fasten the flat display panel onto the optical film.

9. The flat display module of claim 1, further comprising at least an adhesive disposed between the flat display panel and the optical film for adhering the flat display panel to the optical film.

10. The flat display module of claim 9, wherein the adhesive is selected from a group consisting of twin adhesive, UV glue, and hot glue.

11. The flat display module of claim 1, further comprising at least an adhesive disposed between the light guide plate and the optical film for adhering the optical film to the light guide plate.

12. The flat display module of claim 11, wherein the adhesive is selected from a group consisting of twin adhesive, UV glue, and hot glue.

13. The flat display module of claim 1, further comprising at least a light source generator.

14. The flat display module of claim 13, wherein the light source generator is disposed on one side of the light guide plate.

15. The flat display module of claim 1, wherein the optical film is a diffusion sheet, a prism sheet, or a flexible reflective polarizing film.

16. The flat display module of claim 1, wherein a length and a width of the flat display panel are smaller than those of the light guide plate.

17. The flat display module of claim 1, further comprising a reflection sheet disposed at a bottom of the light guide plate.
